(19) United States
(12) Patent Application Publication
(10) Pub. No.: US 2013/0183641 A1
(43) Pub. Date: Jul. 18, 2013

(54) BRAILLE READING-WRITING DEVICE

(71) Applicants: PROTEK (SHANGHAI) LIMITED, Shanghai (CN); PEGATRON CORPORATION, Taipei City (TW)

(72) Inventors: Chung-Kin WONG, Shanghai (CN); Wen-Chi KUO, Taipei City (TW)

(73) Assignees: PEGATRON CORPORATION, Taipei City (TW); PROTEK (SHANGHAI) LIMITED, Shanghai (CN)

(21) Appl. No.: 13/733,666

(22) Filed: Jan. 3, 2013

(30) Foreign Application Priority Data
Jan. 13, 2012 (CN) 201210010996.5

(51) Int. Cl. G09B 21/02

(52) U.S. Cl. CPC G09B 21/025
USPC 434/113

(57) ABSTRACT

A braille reading-writing device includes a body and a plurality of braille buttons. The body has a first surface and a second surface. The braille buttons are disposed through the body. Each of the braille buttons includes a pressing portion located at the same side with the first surface and a touching portion located at the same side with the second surface. The touching portion protrudes from the second surface when the pressing portion is pressed. The braille reading-writing device allows the blind people to write braille on the first surface and to touch to read the written braille on the second surface, thereby integrating the functions of writing and reading braille.

### CROSS REFERENCE TO RELATED APPLICATIONS

This Non-provisional application claims priority under 35 U.S.C. §119(a) on Patent Application No(s). 201210010996.5 filed in People's Republic of China on Jan. 13, 2012, the entire contents of which are hereby incorporated by reference.

### BACKGROUND OF THE INVENTION

1. Field of Invention

The invention relates to a learning device and, in particular, to a braille reading-writing device.

2. Related Art

The braille is a system provided to the blind people for recognizing the letters, and a basic unit of the braille is a 6-dot cell in a rectangular form. As shown in FIG. 1, these six dots are arranged into an array of two columns and three rows where the dots of the left column are called the dot 1, dot 2, and dot 3, respectively, from top to bottom and the dots of the right column are called the dot 4, dot 5, and dot 6, respectively, from top to bottom.

Each dot has two states such as a protruding state and an un-protruding state. Therefore, six dots can collectively provide 64 combinations. Many kinds of devices, such as the braille board, the braille machine, and the braille printer, can provide the dots of different combinations on the back of the paper so that the front of the paper can show different letters, numbers, initial consonants, compound vowels, etc. As shown in FIG. 2, when the dots 1, 2, 4 of the front protrude, it represents the English letter “f” (the mark “+” in the figure indicates the protruding dot)

However, the blind people can only do the touch practice by the above method, and cannot do the reading-writing practice at the same time.

### SUMMARY OF THE INVENTION

The invention is to provide a braille reading-writing device to solve the aforementioned problem.

A braille reading-writing device according to the invention includes a body and a plurality of braille buttons. The body has a first surface and a second surface which are tactilely distinguishable. The braille buttons are disposed through the body. Each of the braille buttons has a pressing portion and a touching portion. The pressing portion and the first surface are located at the same side, and the touching portion and the second surface are located at the same side. When the pressing portion is pressed, the touching portion protrudes from the second surface.

As mentioned above, the blind people can write braille on the first surface of the braille reading-writing device according to the invention, and then they can touch to read the written braille on the second surface thereof. Therefore, in the invention, the functions of writing and reading braille are integrated into the same device, and operation habits of the blind people are greatly conformed to.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a basic unit of the braille;

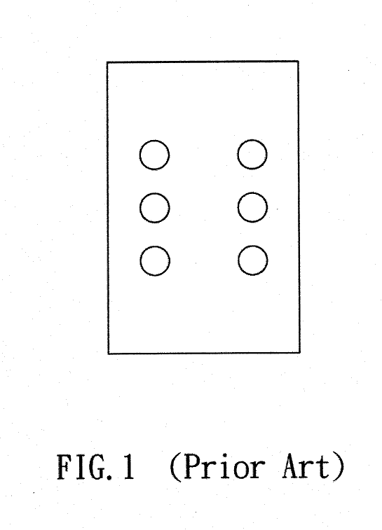

FIG. 2 is a schematic diagram of the braille letter representing the English letter “f”;

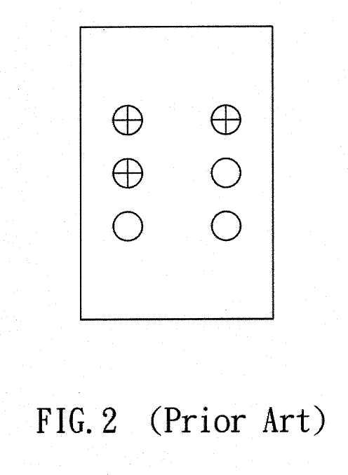

FIG. 3 is a schematic diagram of a braille reading-writing device according to the first embodiment of the invention;

FIG. 4 is a sectional diagram of the braille reading-writing device taken along the line A-A in FIG. 3;

FIG. 5 is a sectional diagram schematically showing a braille reading-writing device according to the second embodiment of the invention;

FIG. 6 is a sectional diagram schematically showing a braille reading-writing device according to the third embodiment of the invention;

FIG. 7 is a sectional diagram schematically showing a braille reading-writing device according to the fourth embodiment of the invention;

FIG. 8 is a schematic diagram of a voice control unit of the braille reading-writing device according to the fifth embodiment of the invention; and

FIG. 9 is a schematic diagram of a voice control unit of a braille reading-writing device according to the sixth embodiment of the invention.

### DETAILED DESCRIPTION OF THE INVENTION

The present invention will be apparent from the following detailed description, which proceeds with reference to the accompanying drawings, wherein the same references relate to the same elements.

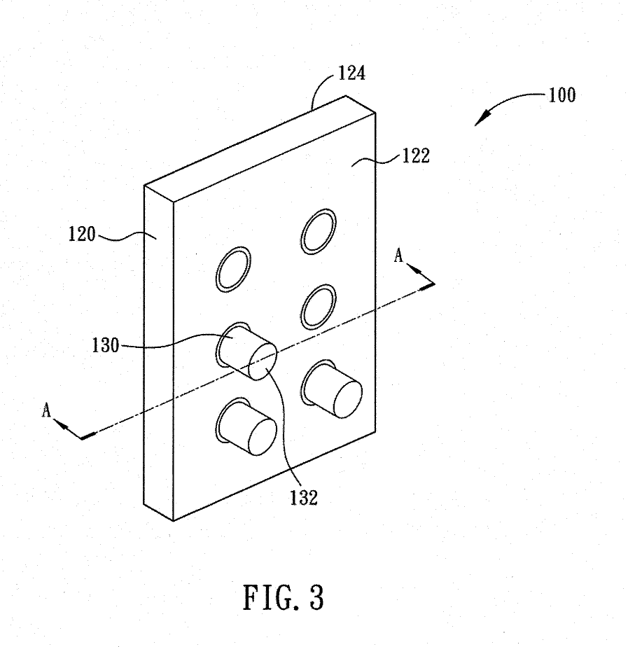

FIG. 3 is a schematic diagram of a braille reading-writing device 100 according to the first embodiment of the invention. The braille reading-writing device 100 includes a body 120 and a plurality of braille buttons 130. The body 120 includes a first surface 122 and a second surface 124. Herein, the first and the second surfaces 122 and 124 can be tactilely distinguishable. In this embodiment, the first and the second surfaces 122 and 124 can be the opposite surfaces of the body 120.

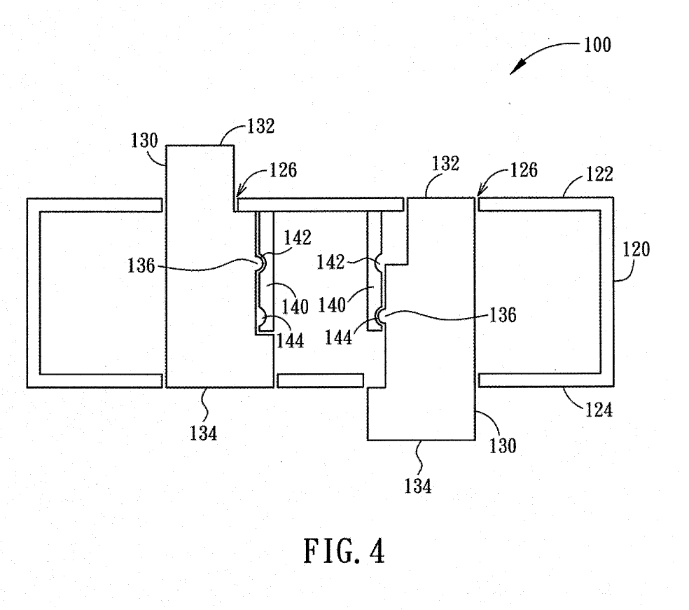

FIG. 4 is a sectional diagram of the braille reading-writing device 100 taken along the line A-A in FIG. 3. In FIG. 4, the braille buttons 130 are disposed through the body 120, and each includes a pressing portion 132 and a touching portion 134. The pressing portion 132 and the first surface 122 are located at the same side, and the touching portion 134 and the second surface 124 are located at the same side. In this embodiment, the pressing portion 132 of the braille button 130 can move between a first position and a second position relative to the body 120 thus to allow the touching portion 134 to move together.

Specifically, in an initial state, the pressing portion 132 is located at the first position shown by the left braille button 130 in FIG. 4 when it has not been pressed. In this embodiment, when the pressing portion 132 is located at the first position, the braille button 130 protrudes from the first surface 122 of the body 120 for facilitating the operation of the user. However, the invention is not limited thereto. For example, in other embodiments, the pressing portion 132 in the initial state also can be slightly concaved towards the body 120. In the embodiment, as shown by the right braille button 130 in FIG. 4, when the pressing portion 132 is pressed to the second position from the first position, it drives the touching portion 134 to protrude from the second surface 124 of the body 120. When the pressing portion 132 reaches the second position, the pressing portion 132 of the braille button 130 can be leveled with the first surface 122 of the body 120. However, the invention is not limited thereto. In other embodiments, when the pressing portion. 132 reaches the second position, it can be slightly lower or higher than the first surface 122 of the body 120.

In FIG. 3, when the pressing portions 132 of the braille buttons 130 respectively representing the dots 3, 5, 6 (observed facing the second surface 124, the dots of the left column are respectively called the dots 1, 2, 3 from top to bottom and the dots of the right column are respectively called the dots 4, 5, 6 from top to bottom) are not pressed (i.e. at the initial state), they are all at the first position. When the pressing portions 132 of the braille buttons 130 respectively representing the dots 1, 2, 4 are pressed, they are at the second position, i.e. the pressed state. The pressing operation simulates making braille symbols on the braille paper via a braille pen, i.e. the writing action. The state of the braille buttons 130 in FIG. 3 represents that a letter “f” is written. As the pressing portion 132 of a certain braille button 130 is pressed from the first surface 122, the touching portion 134 of the corresponding braille button 130 protrudes from the second surface 124. After the pressing operation is completed, the braille reading-writing device 100 can be turned over and thus the touching portions of the braille buttons 130 on the second surface 124 can be touched. The blind people can recognize the corresponding letter and know its meaning via the touch. For example, in this embodiment, the pressing portions 132 of the braille buttons 130 respectively representing the dots 1, 2, 4 are pressed from the first surface 122 to allow the touching portions 134 of the braille buttons 130 respectively representing the dots 1, 2, 4 to protrude from the second surface. After turning over the braille reading-writing device 100, the blind people can recognize the letter “f” via the touch.

As mentioned above, the first and the second surfaces 122 and 124 can be tactilely distinguishable, thereby making the blind people know from which surface they should press the braille buttons 130. There are many ways to make the first and the second surfaces 122 and 124 easily tactilely distinguishable. For example, they can be made of different materials so as to have two kinds of touch feelings. For example, the first surface 122 can be made of plastics while the second surface 124 is made of rubber, and vice versa. Otherwise, the first and the second surfaces 122 and 124 can have different hardness or roughness. Even a protrusion can be disposed on one of the first surface 122 and the second surface 124 for the distinguishability. However, the invention is not limited thereto, and any means that can help to tactilely distinguish the first surface 122 from the second surface 124 can be used.

In addition, in this embodiment, for improving the touch feeling of the touching portion 134, its hardness can be larger than that of the pressing portion 132. For example, the touching portion 134 can be made of plastics while the pressing portion 132 can be made of rubber. However, in other embodiments, the touching portion 134 and the pressing portion 132 can be made of the same material, such as rubber.

In FIG. 4, in this embodiment, the body 120 includes a plurality of through holes 126 passing through the first and the second surfaces 122 and 124, and the braille buttons 130 are disposed through the through holes 126, respectively. However, in other embodiments, the body 120 and the braille buttons 130 can be integrally formed.

In FIG. 4, in this embodiment, the braille reading-writing device 100 further includes a plurality of elastic positioning boards 140 disposed at an inner wall of the body 120. Each of the elastic positioning boards 140 has a first positioning hole 142 and a second positioning hole 144 both of which face the corresponding braille button 130. An outer surface of each of the braille buttons 130 has a positioning protrusion 136 corresponding to the first and the second positioning holes 142 and 144. When the pressing portion 132 is at the first position, the positioning protrusion 136 is disposed in the first positioning hole 142. When the pressing portion 132 is pressed to leave the first position, the elastic positioning board 140 is tilted away from the braille button 130 thus to allow the positioning protrusion 136 to leave the first positioning hole 142. Accordingly, the pressing portion 132 moves towards the second position. When the pressing portion 132 moves to the second position, the positioning protrusion 136 moves into the second positioning hole 144, thus positioning the pressing portion 132 at the second position. By the aforementioned structure, the braille button 130 can be positioned at the first and the second positions, respectively.

In this embodiment, the blind people can write braille on the first surface 122 of the braille reading-writing device 100, and touch to read the written braille on the second surface 124 thereof. Thereby, the functions of writing braille and reading braille are integrated into the same device.

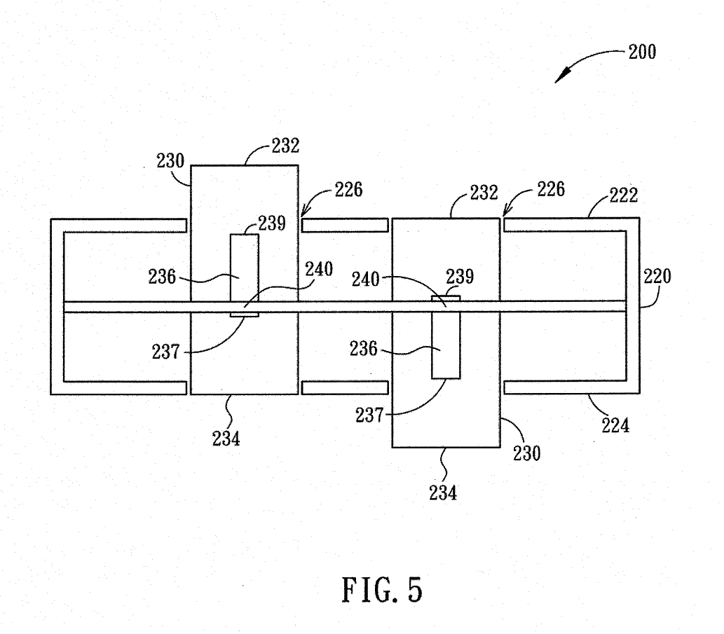

FIG. 5 is a sectional diagram schematically showing a braille reading-writing device 200 according to the second embodiment of the invention. In this embodiment, the braille reading-writing device 200 includes a body 220 and a plurality of braille buttons 230. The body 220 includes a first surface 222 and a second surface 224. Herein, the first and the second surfaces 222 and 224 can be tactilely distinguishable. In this embodiment, the first and the second surfaces 222 and 224 can be the opposite surfaces of the body 220. The braille buttons 230 are disposed through the body 220, and each includes a pressing portion 232 and a touching portion 234. The pressing portion 232 and the first surface 222 are located at the same side, and the touching portion 234 and the second surface 224 are located at the same side. In this embodiment, the body 220 includes a plurality of through holes 226 passing through the first and the second surfaces 222 and 224, and the braille buttons 230 are disposed through the through holes 226, respectively. In other embodiments, the body 220 and the braille buttons 230 can be integrally formed.

Like the pressing portion 132 in the first embodiment, the pressing portion 232 also moves between the first and the second positions. However, in this embodiment, the braille buttons 230 and the positioning method thereof are different from the braille buttons 130 in FIG. 4. In this embodiment, the braille reading-writing device 200 includes a limiting board 240 disposed in the body 220. The limiting board 240 can be fixed to an inner wall of the body 220 such as by screwing or locking. Each of the braille buttons 230 has a limiting through hole 236 having a first inner wall 237 and a second inner wall 239 opposite to each other. The limiting board 240 is disposed through the limiting through hole 236. When the pressing portion 232 is at the first position, the first inner wall 237 is disposed against the limiting board 240, as shown by the left braille button 230 in FIG. 5. When the pressing portion 232 is pressed to the second position, the second inner wall 239 is disposed against the limiting board 240 and the touching portion 234 protrudes from the second surface 224, as shown by the right braille button 230 in FIG. 5. By the aforementioned structure, the braille button 230 can be positioned at the first and the second positions, respectively.

In FIG. 5, in this embodiment, when the pressing portion 232 is at the first position, the braille button 230 protrudes from the first surface 222 of the body 220. When the pressing portion 232 reaches the second position, the pressing portion 232 of the braille button 230 is leveled with the first surface 222. However, the invention is not limited thereto.

In other aspects, the braille reading-writing device 200 is the same as or similar to the braille reading-writing device 100 in the first embodiment, and therefore it is not described for concise purpose.

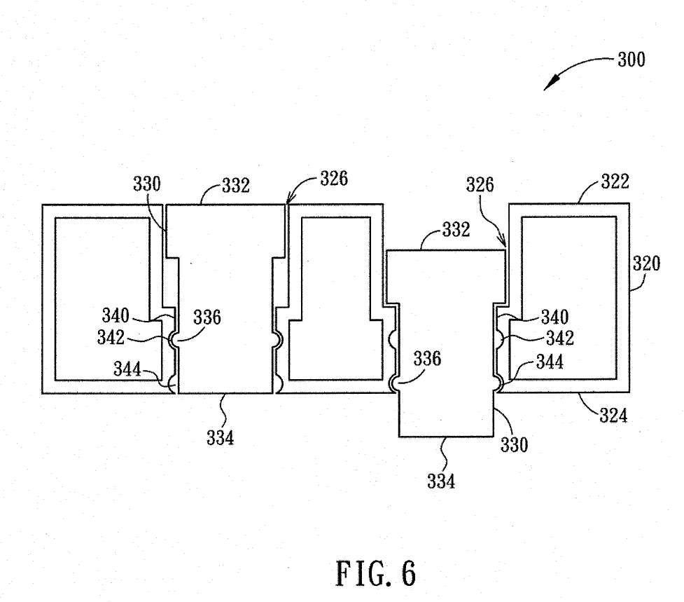

FIG. 6 is a sectional diagram schematically showing a braille reading-writing device 300 according to the third embodiment of the invention. In this embodiment, the braille reading-writing device 300 includes a body 320 and a plurality of braille buttons 330. The body 320 includes a first surface 322 and a second surface 324. Herein, the first and the second surfaces 322 and 324 can be tactilely distinguishable. In this embodiment, the first and second surfaces 322 and 324 can be the opposite surfaces of the body 320. The braille buttons 330 are disposed through the body 320, and each includes a pressing portion 332 and a touching portion 334. The pressing portion 332 and the first surface 322 are located at the same side, and the touching portion 334 and the second surface 324 are located at the same side. In this embodiment, the body 320 includes a plurality of through holes 326 passing through the first and the second surfaces 322 and 324, and the braille buttons 330 are disposed through the through holes 326, respectively. However, in other embodiments, the body 320 and the braille buttons 330 can be integrally formed.

Like the pressing portions 132 and 232 in the first and the second embodiments, the pressing portion 332 also moves between the first and second positions. However, in this embodiment, the braille buttons 330 and the positioning method thereof are different from the braille buttons 130 and 230 in FIGS. 4 and 5. In this embodiment, an outer surface of the braille button 330 has an annular elastic protrusion 336, and an inner wall of the body 320 has an extending portion 340 including a first annular positioning recess 342 and a second annular positioning recess 344 both corresponding to the annular elastic protrusion 336. When the pressing portion 332 is at the first position, the annular elastic protrusion 336 is located in the first annular positioning recess 342. When the pressing portion 332 is pressed to leave the first position, the annular elastic protrusion 336 deforms elastically and then leaves the first annular positioning recess 342. When the pressing portion 332 reaches the second position, the annular elastic protrusion 336 is located in the second annular positioning recess 344 and the touching portion 334 protrudes from the second surface 324. By the aforementioned structure, the braille button 330 can be positioned at the first and the second positions, respectively.

In FIG. 6, in this embodiment, when the pressing portion 332 is at the first position, the pressing portion 332 of the braille button 330 is leveled with the first surface 322 of the body 320. In addition, when the pressing portion 332 is pressed to the second position, the pressing portion 332 is concaved inward from the first surface 322. However, the invention is not limited thereto.

In other aspects, the braille reading-writing device 300 is the same as or similar to the braille reading-writing devices 100 or 200 in the first or the second embodiments, and therefore it is not described for concise purpose.

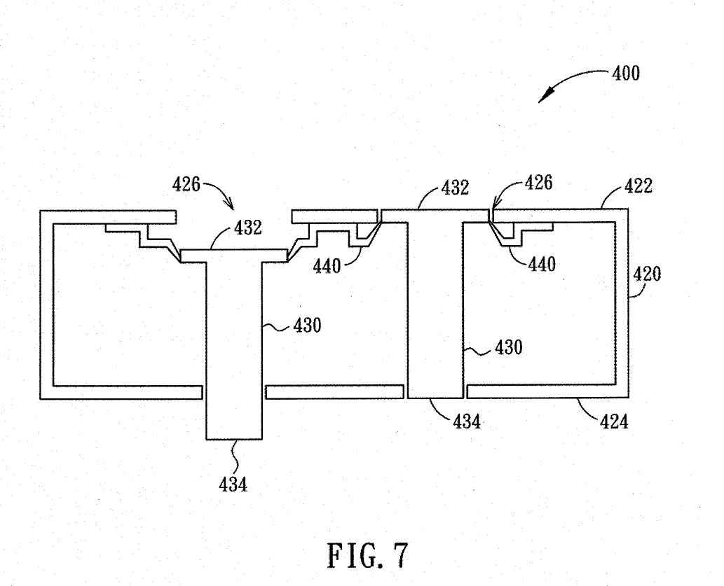

FIG. 7 is a sectional diagram schematically showing a braille reading-writing device 400 according to the fourth embodiment of the invention. In this embodiment, the braille reading-writing device 400 includes a body 420 and a plurality of braille buttons 430. The body 420 includes a first surface 422 and a second surface 424. Herein, the first and the second surfaces 422 and 424 can be tactilely distinguishable. In this embodiment, the first and the second surfaces 422 and 424 can be the opposite surfaces of the body 420. The braille buttons 430 are disposed through the body 420, and each includes a pressing portion 432 and a touching portion 434. The pressing portion 432 and the first surface 422 are located at the same side, and the touching portion 434 and the second surface 424 are located at the same side. In this embodiment, the body 420 includes a plurality of through holes 426 passing through the first and the second surfaces 422 and 424, and the braille buttons 430 are disposed through the through holes 426, respectively. In other embodiments, the body 420 and the braille buttons 430 can be integrally formed.

Like the pressing portions 132, 232 and 332 in the first, the second and the third embodiments, the pressing portion 432 also moves between the first and the second positions. However, in this embodiment, the braille buttons 430 and the positioning method thereof are different from the braille buttons 130, 230 and 330 in FIGS. 4 to 6. In this embodiment, the braille reading-writing device 400 includes a plurality of silica elastic arms 440 disposed at an inner wall of the body 420 and connected with the braille buttons 430, respectively. Each of the silica elastic arms 440 has two positioning points, i.e. an upper positioning point and a lower positioning point. In FIG. 7, the silica elastic arm 440 connected with the right braille button 430 in FIG. 7 is at the upper positioning point to allow the pressing portion 432 to be at the first position. When the braille button 430 is pressed, the elastic force of the silica elastic arm 440 needs to be overcome. When the silica elastic arm 440 is lowered down to the lower positioning point by the driving of the braille button 430, the pressing portion 432 is positioned at the second position to allow the touching portion 434 to protrude from the second surface 424 as shown by the left braille button 430 in FIG. 7. By the aforementioned structure, the braille button 430 can be positioned at the first and the second positions, respectively.

In FIG. 7, in this embodiment, when the pressing portion 332 is at the first position, the pressing portion 332 of the braille button 430 is leveled with the first surface 422 of the body 420. In addition, when the pressing portion 432 is pressed to the second position, the pressing portion 332 is concaved inward from the first surface 422. However, the invention is not limited thereto.

In other aspects, the braille reading-writing device 400 is the same as or similar to the braille reading-writing devices 100, 200 or 300 in the first, the second or the third embodiments, and therefore it is not described for concise purpose.

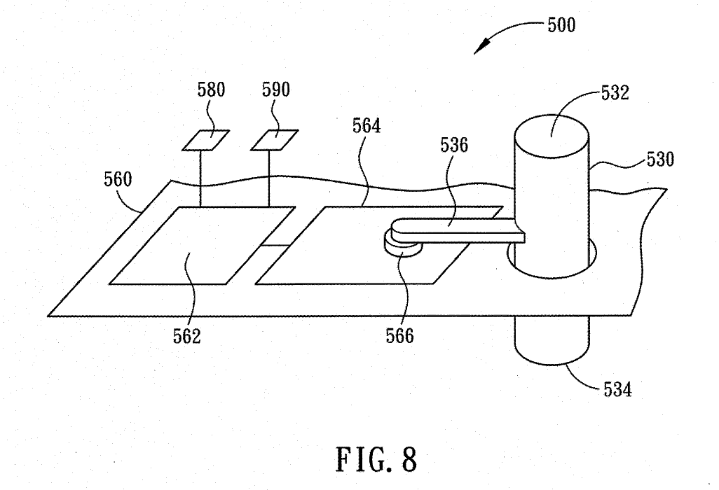

In the fifth embodiment of the invention, for helping the blind people determine whether the braille they write or read is correct or not, the braille reading-writing device can be configured with a voice control unit. FIG. 8 is a schematic diagram of a voice control unit 560 of the braille reading-writing device 500 according to the fifth embodiment of the invention. Except adding the voice control unit 560, the mechanism of the braille reading-writing device 500 can be designed as the braille reading-writing device 100, 200, 300, or 400. Accordingly, the mechanism of the braille reading-writing device 500 is mostly omitted in FIG. 8, and only a braille button and part of the voice control unit 560 are illustrated.

In FIG. 8, the braille reading-writing device 500 includes the voice control unit 560. The voice control unit 560 includes a voice element 562 and a control circuit board 564 which is disposed in the body (not shown) and electrically connected with the voice element 562. The control circuit board 564 includes a plurality of signal contacts 566 corresponding to the braille buttons 530. The braille button 530 includes a pressing portion 532 and a touching portion 534, and when the pressing portion 532 is pressed, the corresponding signal contact 566 is electrically connected with the corresponding braille button 530 and thus the voice element 562 voices the corresponding content.

In FIG. 8, in this embodiment, the braille button 530 includes a conductive portion 536 disposed between the pressing portion 532 and the touching portion 534. When the pressing portion 532 is pressed, the conductive portion 536 moves towards the corresponding signal contact 566 and is electrically connected with the signal contact 566. The conductive portion 536 is preferably a flexible conductive element, such as conductive cloth, conductive foam plastics, or a metal elastic sheet, for enhancing the touch feeling of pressing the braille button 530.

In this embodiment, the braille reading-writing device 500 can further include a voice enabling button 580 electrically connected with the voice element 562. When the voice enabling button 580 is pressed, the voice element 562 voices the corresponding content according to the conducting states of the signal contacts 566 and the corresponding braille buttons 530. Thereby, after writing or reading braille, the blind people can hear the sound corresponding to the braille letters to determine whether the writing or reading is correct or not.

In other embodiments, the braille reading-writing device 500 may detect conducting states of the signal contacts 566 and the corresponding braille buttons 530 to automatically voice the corresponding content after each of the pressing operations. Accordingly, when a braille letter needs to be made by pressing a plurality of braille buttons 530, the sound of an interim braille letter, instead of the expected braille letter, may be heard after a certain pressing operation.

In fact, the meaning of a specific braille letter depends on the man-made mapping relationship between the braille letter and its meaning. For example, English alphabet, Mainland China alphabet, and Chinaese phonetic alphabet have their respective mapping relationships between the braille letter and the meaning. Accordingly, for supporting multiple languages, the braille reading-writing device 500 can include a language selecting button 590 electrically connected with the voice element 562 in FIG. 8. The voice element 562 voices the content in the corresponding language according to the input of the language selecting button 590. For example, when the input of the language selecting button 590 is corresponding to English, the voice element 562 voices the content corresponding to the written braille letter in English. In addition, when Mainland China alphabet or Chinaese phonetic alphabet is selected, the voice element 562 voices the content corresponding to the written braille letter in Mainland China alphabet or Chinaese phonetic alphabet. Accordingly, the voice element 562 may include a multi-speech database or be electrically connected with a multi-speech database.

The form of the braille button 530 in FIG. 8 is just for example, and it can use the structure of the braille button 130, 230, 330, or 430 in the first, the second, the third, or the fourth embodiments. However, the invention is not limited thereto; in other embodiments, the braille button 530 can have any proper form.

In other aspects, the braille reading-writing device 500 is the same as or similar to the braille reading-writing devices 100, 200, 300 or 400 in the first, the second, the third or the fourth embodiments, and therefore it is not described for concise purpose.

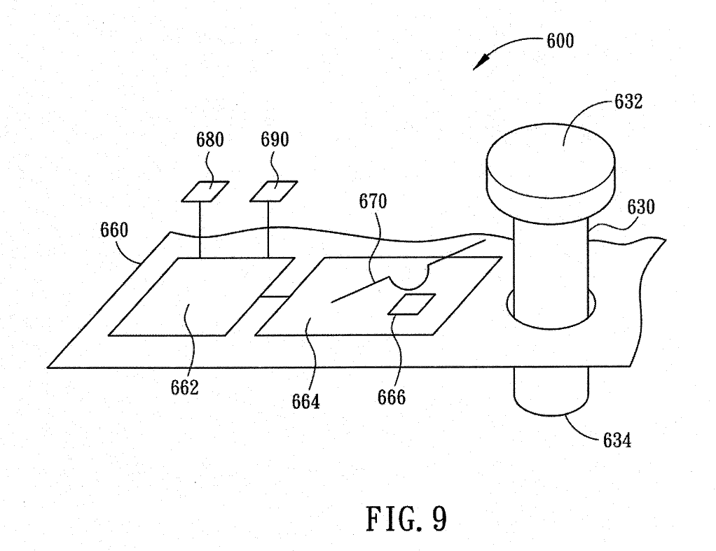

FIG. 9 is a schematic diagram of a voice control unit 660 of a braille reading-writing device 600 according to the sixth embodiment of the invention. Like FIG. 8, the mechanism of the braille reading-writing device 600 is mostly omitted in FIG. 9, and only a braille button and part of the voice control unit 660 are illustrated.

In FIG. 9, the braille reading-writing device 600 includes the voice control unit 660. The voice control unit 660 includes a voice element 662 and a control circuit board 664 which is disposed in the body (not shown) and electrically connected with the voice element 662. The control circuit board 664 includes a plurality of signal contacts 666 corresponding to the braille buttons 630. The braille button 630 includes a pressing portion 632 and a touching portion 634, and when the pressing portion 632 is pressed, the corresponding signal contact 666 is electrically connected with the corresponding braille button 630 and the voice element 562 thus voices the corresponding content.

In FIG. 9, in this embodiment, the braille reading-writing device 600 further includes a conductive elastic sheet 670. One end of the conductive elastic sheet 670 is fixed to the control circuit board 664 while the other end is suspended above the control circuit board 664. When the pressing portion 632 is pressed, the braille button 630 presses the other end of the conductive elastic sheet 670 to allow the other end of the conductive elastic sheet 670 to move towards the signal contact 666 thus to be electrically connected with the signal contact 666.

Like the fifth embodiment, the braille reading-writing device 600 in this embodiment can further include a voice enabling button 680 and a language selecting button 690 both of which are electrically connected with the voice element 662. The functions and operations of the voice enabling button 680 and language selecting button 690 are similar to those of the voice enabling button 580 and the language selecting button 590 of the braille reading-writing device 500, and therefore they are not described for concise purpose.

The form of the braille button 630 in FIG. 9 is just for example, and it can use the structure of the braille button 130, 230, 330, or 430 in the first, the second, the third, or the fourth embodiments. However, the invention is not limited thereto, and in other embodiments, the braille button 630 can have any proper form.

In other aspects, the braille reading-writing device 600 is the same as or similar to the braille reading-writing devices 100, 200, 300, 400 or 500 in the first, the second, the third, the fourth or the fifth embodiments, and therefore it is not described for concise purpose.

In summary, the blind people can write braille on the first surface of the braille reading-writing device according to the embodiments of the invention, and they can touch to read the written braille on the second surface thereof Therefore, in the embodiments of the invention, the functions of writing and reading the braille are integrated into the same device, and operation habits of the blind people are greatly conformed to.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A braille reading-writing device, comprising:
a body having a first surface and a second surface which are tactilely distinguishable; and
a plurality of braille buttons disposed through the body, wherein each of the braille buttons has a pressing portion and a touching portion, the pressing portion and the first surface are located at the same side, the touching portion and the second surface are located at the same side, and when the pressing portion is pressed, the touching portion protrudes from the second surface.

2. The braille reading-writing device according to claim 1, wherein the first surface and the second surface are made of different materials.

3. The braille reading-writing device according to claim 1, wherein one of the first and second surfaces has a protrusion.

4. The braille reading-writing device according to claim 1, wherein the hardness of the pressing portion is less than that of the touching portion.

5. The braille reading-writing device according to claim 1, wherein the body and the braille buttons are integrally formed.

6. The braille reading-writing device according to claim 1, wherein the body has a plurality of through holes passing through the first surface and the second surface, and the braille buttons are disposed through the through holes, respectively.

7. The braille reading-writing device according to claim 1, further comprising a plurality of elastic positioning boards disposed at the inner wall of the body, wherein each of the elastic positioning boards has a first positioning hole and a second positioning hole both facing the corresponding braille button, an outer surface of each of the braille buttons has a positioning protrusion corresponding to the first positioning hole and the second positioning hole, when the pressing portion is at a first position, the positioning protrusion is disposed in the corresponding first positioning hole, and when the pressing portion is pressed to a second position from the first position, the positioning protrusion is disposed in the corresponding second positioning hole.

8. The braille reading-writing device according to claim 1, further comprising a limiting board disposed in the body, wherein each of the braille buttons has a limiting through hole having a first inner wall and a second inner wall opposite to each other, the limiting board is disposed through the limiting through hole, when the pressing portion is at a first position, the first inner wall is disposed against the limiting board, and when the pressing portion is pressed to a second position from the first position, the second inner wall is disposed against the limiting board.

9. The braille reading-writing device according to claim 1, wherein an outer surface of each of the braille buttons has an annular elastic protrusion, an inner wall of the body has an extending portion including a first annular positioning recess and a second annular positioning recess both corresponding to the annular elastic protrusion, when the pressing portion is at a first position, the annular elastic protrusion is located in the first annular positioning recess, and when the pressing portion is pressed to a second position from the first position, the annular elastic protrusion is located in the second annular positioning recess.

10. The braille reading-writing device according to claim 1, further comprising a silica elastic arm disposed at an inner wall of the body and connected with the braille buttons, respectively.

11. The braille reading-writing device according to claim 1, further comprising a voice control unit including a voice element and a control circuit board disposed in the body and electrically connected with the voice element, wherein the control circuit board includes a plurality of signal contacts corresponding to the braille buttons, and when the pressing portion is pressed, the corresponding signal contact is electrically connected with the corresponding braille button and thus the voice element voices the corresponding content.

12. The braille reading-writing device according to claim 11, wherein each of the braille buttons comprises a conductive portion disposed between the pressing portion and the touching portion, and when the pressing portion is pressed, the conductive portion moves towards the corresponding signal contact and is electrically connected with the signal contact.

13. The braille reading-writing device according to claim 12, wherein the conductive portion is made of conductive cloth, conductive foam plastics, or a metal elastic sheet.

14. The braille reading-writing device according to claim 11, further comprising a conductive elastic sheet with one end fixed to the control circuit board and the other end suspended above the control circuit board, wherein when the pressing portion is pressed, the braille button presses the other end of the conductive elastic sheet to allow the other end of the conductive elastic sheet to move towards the signal contact thus to be electrically connected with the signal contact.

15. The braille reading-writing device according to claim 11, further comprising a voice enabling button electrically connected with the voice element, wherein when the voice enabling button is pressed, the voice element voices the corresponding content according to the conducting states of the signal contacts and the corresponding braille buttons.

16. The braille reading-writing device according to claim 11, further comprising a language selecting button electrically connected with the voice element, wherein the voice element voices the content in the corresponding language according to the input of the language selecting button.
